(19) United States
(12) Patent Application Publication
(10) Pub. No.: US 2018/0077049 A1
(43) Pub. Date: Mar. 15, 2018

(54) SYSTEMS AND METHODS FOR DETERMINING AND ATTRIBUTING NETWORK COSTS AND DETERMINING ROUTING PATHS OF TRAFFIC FLOWS IN A NETWORK

(71) Applicants: Mohinder Paul, Gurgaon (IN); Anita Tailor, Gurgaon (IN); Anant Malhotra, New Delhi (IN); Pragati Dhingra, New Delhi (IN); Aditya Kumar, Gurgaon (IN)

(72) Inventors: Mohinder Paul, Gurgaon (IN); Anita Tailor, Gurgaon (IN); Anant Malhotra, New Delhi (IN); Pragati Dhingra, New Delhi (IN); Aditya Kumar, Gurgaon (IN)

(21) Appl. No.: 15/262,508

(22) Filed: Sep. 12, 2016

(51) Int. Cl. H04L 12/729; H04L 12/24; H04L 12/26

(52) U.S. Cl. CPC H04L 45/125; H04L 41/0826; H04L 41/0896; H04L 43/0888; H04L 43/0882

(57) ABSTRACT

Embodiments of the present invention include approaches for selecting a routing path of a data set from its source to its destination on a network and allocating a network cost for delivering the data set. The approaches include collecting traffic information on the network, determining one or more routing paths from the source to the destination, computing network cost(s) associated with the routing path(s), selecting a routing path based on the associated network costs, a flow value associated with the data set, and the collected traffic information, and allocating the network cost to network users in accordance with a cost policy.

### TECHNICAL FIELD

In various embodiments, the present invention relates generally to network communications, and in particular to calculating and allocating appropriate network costs to customers sending/receiving traffic on the network and determining routing path of traffic flows.

### BACKGROUND

Computer networks, including cellular/mobile networks, wireless networks, and wired networks (or portions thereof) allow data exchange between computational entities. For example, an Internet Protocol based network (IP network) includes a group of computers that use Internet Protocol for communication at the network layer. An IP network typically includes various networking devices, such as links, routers, and interfaces, that are shared amongst the subscribed customers. Costs relevant to the network infrastructure, other capital expenditure and network management are allocated among the customers. Conventionally, network costs have been allocated using regional average method where total cost of a region is distributed among all customer interfaces in proportion to their billed traffic usage rate. This method allocates a uniform cost per Gbps to each customer interface in the region. This cost allocation mechanism, however, may be unfair: it may not account for the customers' cost burden to the network provider if there is little overlap between the customer's peak use and the overall (i.e., the provider's) peak traffic. Additionally it does not account for variance in cost of actual network infrastructure used. For example, a customer using an expensive site and high cost network links should be given a higher cost burden than another customer who is sending exactly the same traffic using a low cost site and using low cost network links.

Another conventional cost allocation mechanism involves a Shapley value, which allocates costs to the customers as a cooperative game. A Shapley cost function spreads the marginal cost of the required bandwidth amongst all the customers who need a bandwidth of at least the amount corresponding to the marginal cost. This mechanism provides several advantages such as more fair cost distribution (i.e., cost assigned to a customer considers the traffic rate as well as cost of the network assets used by such traffic) and symmetry (i.e., two customers having the same contribution are assigned the same cost). The Shapley cost function, however, involves computational complexity and is thus computationally expensive to implement at scale without approximations.

Accordingly, there is a need for an approach that can computationally inexpensively determine the cost of network flow, and fairly allocate network costs with the consideration of the path of the flow within the network and network assets used by the flow.

### SUMMARY

Embodiments of the present invention include approaches that enable a network operator to accurately determine the network asset usage of a data flow and fairly allocate network costs among his/her customers based not only on the used bandwidth but also the origin, destination, and path of the flow. In various embodiments, the network costs are estimated based on depreciated costs of network devices (or assets) on each routing path between a flow source and a destination. The estimated network costs together with maximum usable asset capacity and a daily five-minute peak traffic flow may determine a “daily cost” of each network asset. The determined daily cost together with top M five-minute peak intervals of the daily traffic may determine a “unit cost in each peak interval”. Subsequently, the network costs are allocated to customers based on the determined unit cost of each network asset involved in transmitting the customer's data and the bandwidth usage of the data. Accordingly, the current application ensures that the network costs are fairly allocated to “consistent” users, while ensuring that most costs are allocated to the peak usage. In addition, because the costs are computed based on aggregation of all network asset costs along the data routing path, the routing distance of the data is effectively taken into account in the cost calculation mechanism.

In some embodiments, the network operator includes a policy component in determining which network assets may be used to service customers. For example, the operator may offer his customers a service including more aggressive queuing (i.e., slightly more delay) and/or longer routing paths (i.e., having more hops) at a much lower cost than other network services. This allows customers to select services based on their needs and allows the network operators to direct the traffic with flexibility. In addition, the current invention allows the network operator to obtain information about the network's response to the required bandwidth usage, and perform network adjustments (e.g., modifying routing tables) based on the real-time flow traversing each network element. For example, the operator may route some flows along the shortest paths while routing other flows via longer paths depending on their flow values, overall network costs of the routing paths, and the customers' subscribing service plans. Because approaches described herein involve neither complex computation nor excessive setup, they can be easily implemented in conventional network systems.

Accordingly, in one aspect, the invention pertains to a method of allocating a network cost for delivering traffic from a source to a destination on a network. In various embodiments, the method includes collecting traffic information on the network; determining a routing path from the source to the destination based on the traffic information using one or more routing protocols; computing a unit cost of each network asset located along the determined routing path; computing the network cost based on the unit cost of each network asset and a flow value (e.g., a bit rate) associated with the traffic; and allocating the network cost to network users in accordance with a cost policy. The traffic information may be collected using a network protocol and/or an exterior gateway protocol. In addition, the network assets may be identified using an interior gateway protocol. In one implementation, the cost policy classifies the network users into net senders and net receivers; the net senders send more traffic than they receive and net receivers receive more traffic than they send.

In various embodiments, the unit cost of each network asset is determined based on a monthly depreciated cost, an operating cost, a utilized bandwidth and/or a capacity of the asset. The method further includes computing a daily cost of each network asset based on a ratio of a daily five-minute peak traffic flow to an aggregation of the daily five-minute peak traffic flow in a month. In addition, the method includes determining daily M intervals having maximal five-minute bandwidth usages. The unit cost is computed by dividing the daily cost by a proportion of bandwidth usage within the M intervals. In some embodiments, the network includes multiple forwarding devices; the method further includes the step of altering routing protocols of the forwarding devices based on the traffic information and the network cost.

In another aspect, the invention relates to a system for allocating a network cost for delivering traffic from a source to a destination on a network. In various embodiments, the system includes a memory having a database for storing a cost policy; a collector agent for collecting traffic information on the network; and a processor configured to determine a routing path from the source to the destination based on the traffic information using one or more routing protocols, compute a unit cost of each network asset located on the determined routing path, compute the network cost based on the unit cost of each network asset and a flow value (e.g., a bit rate) associated with the traffic, and allocate the network cost to network users in accordance with the cost policy. The collector agent may be configured to collect the traffic information from a network protocol and/or an exterior gateway protocol. In addition, the assets may be identified using an interior gateway protocol. In one implementation, the cost policy classifies the network users into net senders and net receivers; the net senders send more traffic than they receive and net receivers receive more traffic than they send.

In some embodiments, the processor is further configured to determine the unit cost of each network asset based on a monthly depreciated cost, an operating cost, a utilized bandwidth, and/or a capacity of the asset. In addition, the processor is configured to compute a daily cost of each network asset based on a ratio of a daily five-minute peak traffic flow to an aggregation of the daily five-minute peak traffic flows in a month. Further, the processor is configured to determine daily M intervals having maximal five-minute bandwidth usages. In one embodiment, the processor is configured to compute the unit cost by dividing the daily cost by a proportion of bandwidth usage within the M intervals. In various embodiments, the network includes multiple forwarding devices, and the processor is further configured to alter routing protocols of the forwarding devices based on the traffic information and the computed network cost.

Another aspect of the invention relates to a method of routing a data set from a source to a destination. In various embodiments, the method includes collecting traffic information on the network; determining multiple routing paths from the source to the destination; computing a network cost associated with each one of the routing paths; selecting one of the routing paths based on the associated network costs, a flow value (e.g., a bandwidth) associated with the data set, and the collected traffic information. In some embodiments, the method further includes retrieving a customer's record, retrieving a cost policy associated with the customer's record, and selecting one of the routing paths based at least in part on the cost policy. The customer is associated with the source and/or the destination.

In various embodiments, the traffic information is collected using a network protocol and/or an exterior gateway protocol. The network cost associated with each one of the routing paths is determined based on a unit cost of each network asset located on the routing paths and a bit rate of the data set. The network assets may be identified using an interior gateway protocol. In addition, the unit cost of each network asset may be determined based on a monthly depreciated cost, an operating cost, a utilized bandwidth and/or a capacity of the asset.

In one implementation, the method includes computing a daily cost of each network asset based on a ratio of a daily five-minute peak traffic flow to an aggregation of the daily five-minute peak traffic flow in a month. In addition, the method includes determining daily M intervals having maximal five-minute bandwidth usages. The unit cost on is computed by dividing the daily cost by a proportion of bandwidth usage within the M intervals.

In yet another aspect, the invention pertains to a system for routing a data set from a source to a destination on a network. In various embodiments, the system includes a collector agent for collecting traffic information on the network; and a processor configured to: determine multiple routing paths from the source to the destination; compute a network cost associated with each one of the routing paths; and select one of the routing paths based on the associated network costs, a flow value (e.g., a bandwidth) associated with the data set, and the collected traffic information. In some embodiment, the system further includes a first database for storing customer records and a second database for storing multiple cost policy rules. The processor is further configured to: retrieve, from the first database, a customer's record, retrieve, from the second database, a cost policy rule associated with the customer's record, and select one of the routing paths based at least in part on the retrieved cost policy rule. The customer is associated with the source and/or the destination.

The collector agent may be configured to collect the traffic information from a network protocol and/or an exterior gateway protocol. The processor may be further configured to determine the network cost associated with each one of the routing paths based on a unit cost of each network asset located on the routing paths and a bit rate of the data set. In one embodiment, the network assets are identified using an interior gateway protocol. In addition, the processor is configured to determine the unit cost of each network asset based on a monthly depreciated cost, an operating cost, a utilized bandwidth, and/or a capacity of the asset.

In one implementation, the processor is configured to compute a daily cost of each network asset based on a ratio of a daily five-minute peak traffic flow to an aggregation of the daily five-minute peak traffic flow in a month. In addition, the processor is further to determine daily M intervals having maximal five-minute bandwidth usages. Further, the processor is configured to compute the unit cost by dividing the daily cost by a proportion of bandwidth usage within the M intervals.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIGS. 1A and 1B schematically illustrate centralized and distributed NetFlow architecture, respectively;

FIG. 1C schematically depicts scenarios for deploying an exterior gateway protocol and an interior gateway protocol in the network;

FIGS. 2A and 2B depict approaches for computing network costs for transmitting data packets in accordance with various embodiments;

FIG. 3 illustrates approaches for allocating network costs to customers in accordance with various embodiments;

FIG. 4 is a flow chart illustrating approaches for manipulating a traffic flow in accordance with various embodiments; and

FIG. 5 schematically illustrates a system for calculating and allocating network costs in accordance with various embodiments.

### DESCRIPTION

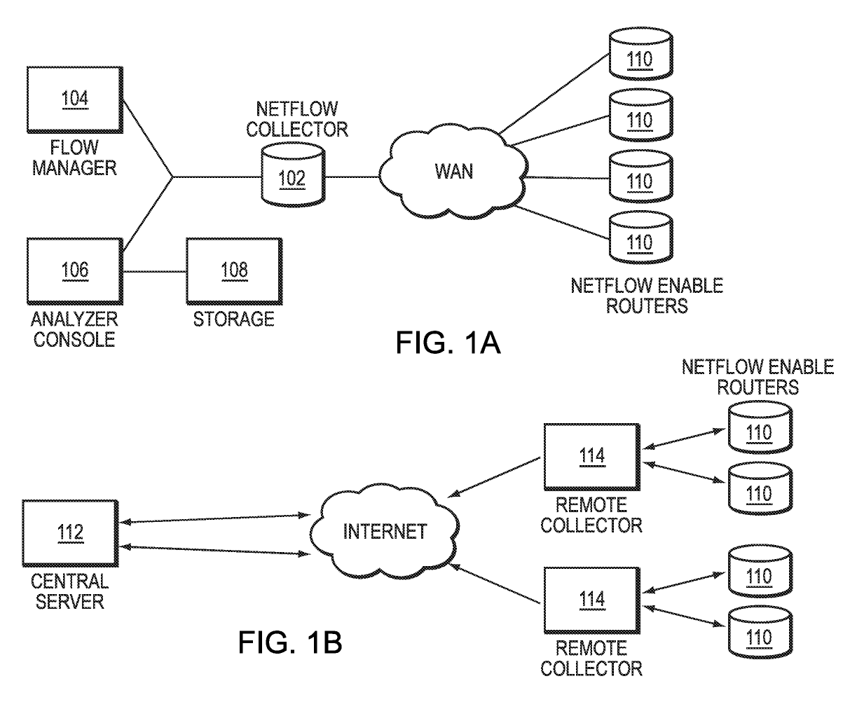

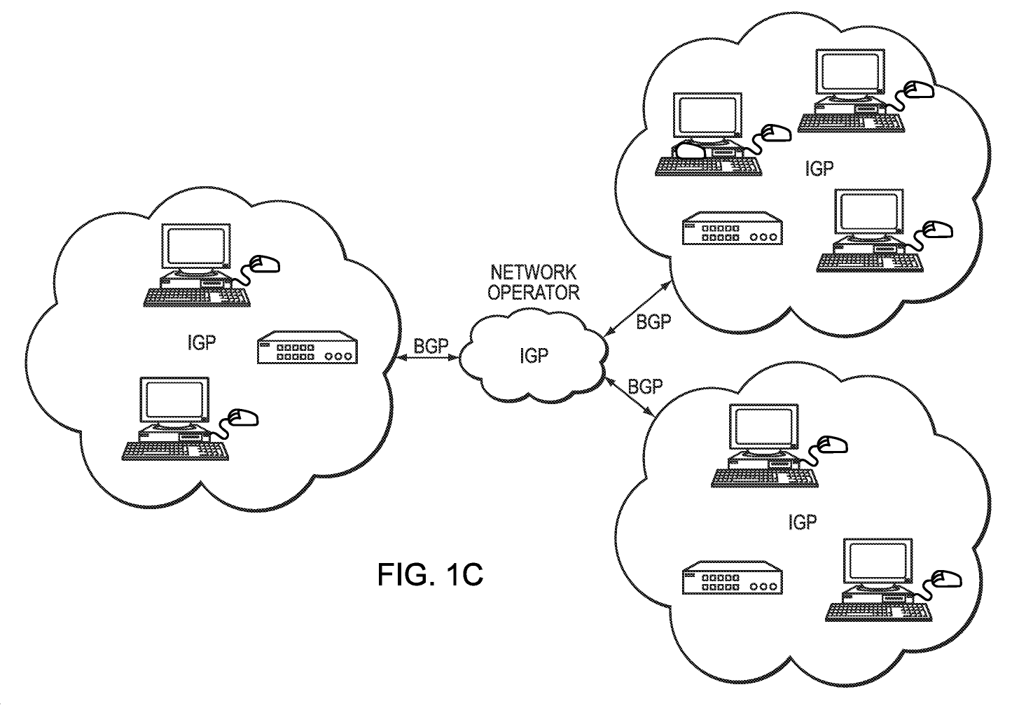

A network service forwards data packets from their origins to destinations using routers that connect multiple networks and determine the “best” path to route the packets. Customers subscribing to the network service share the networking devices (or assets), such as routers, switches, links, interfaces, etc., on the routing paths and are responsible for network costs resulting from the network infrastructure and other capital expenditure and management. In various embodiments, the network costs are attributed to the customers in accordance with data flows, routing paths, and costs of network assets on the routes. To accurately assess the data flows, the data flow routes, and the asset costs on the routes, it is necessary to acquire information about traffic that represents the volumes and attributes of traffic from various interfaces in the network. In one embodiment, the traffic is computed using a network protocol, such as NetFlow. FIG. 1A depicts centralized NetFlow architecture having a NetFlow collector 102, a Netflow manager 104, an analyzer console 106, and a storage unit 108. NetFlow-enabled routers and switches are used in various types of networks (e.g., Internet, intranet, local area network, etc.). These network nodes collect traffic statistics of network flows and output the collected records to the Netflow collector 102 for processing. Upon receiving the aggregated records, the Netflow collector 102 transmits them to the analyzer console 106 that performs traffic analysis on the records; the analysis results may then be stored in the storage unit 108, and may be queried as appropriate by the network manager 104. Thus, by analyzing NetFlow data, a picture of network traffic flows and volumes can be created.

FIG. 1B depicts distributed NetFlow architecture including a single central server 112 and multiple distributed collectors 114; each collector 114 resides near a NetFlow enabled router 110 at the remote location. The collectors 114 collect and process the NetFlow from the routers 110 and passes the data to the central server 112 through, for example, a secure https connection. The central server 112 may analyze and store the received data and generate reports.

Referring to FIG. 1C, in various embodiments, a gateway protocol designed to exchange routing and reachability information among autonomous systems is used cooperatively with the NetFlow data to determine the traffic matrix—i.e., a representation of traffic characteristics and volume between various traffic sources and destinations. In one embodiment, an exterior gateway protocol, such as a border gateway protocol (BGP), obtains exchanged routing information between gateway hosts of different autonomous systems; based on the exchanged routing information and network policies configured by the network operator, a routing decision can be made. For example, a BGP-based system typically contains a routing table having a list of known routers, the addresses they can reach, and a cost metric associated with the interface to each router, and thereby allows the best available route to be chosen. Accordingly, using Netflow (or other network protocols) and BGP (or other exterior gateway protocols), the traffic matrix and various routing paths of the network flows may be determined.

Additionally, in various embodiments, an interior gateway protocol (IGP)-based system that obtains exchanged routing information between gateways within an autonomous system (e.g., a system of corporate local area networks) is utilized to identify internal network assets (e.g., routers, interfaces, and links) used in each autonomous system on the network.

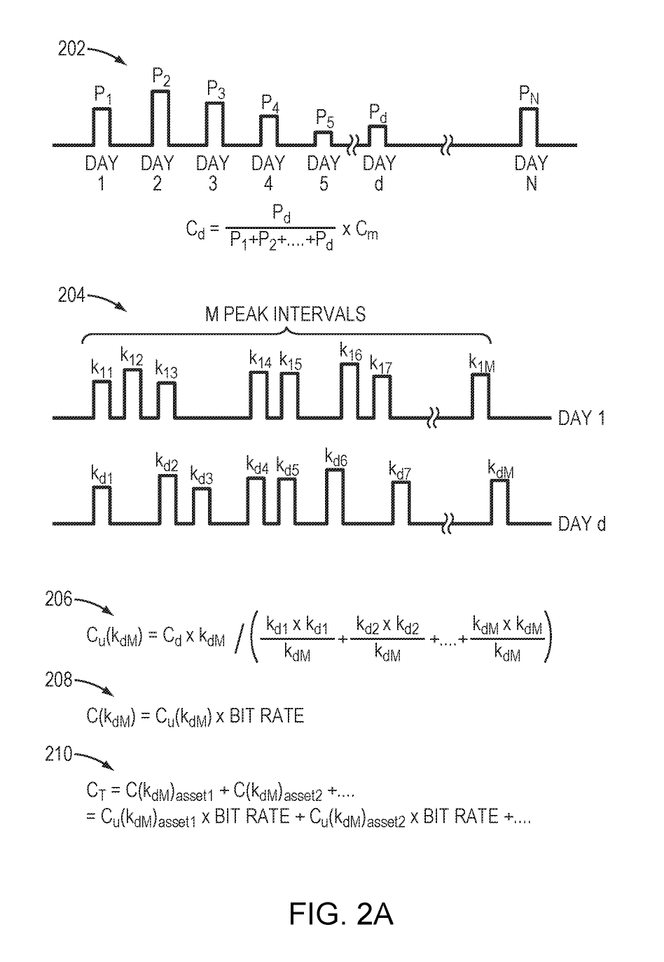

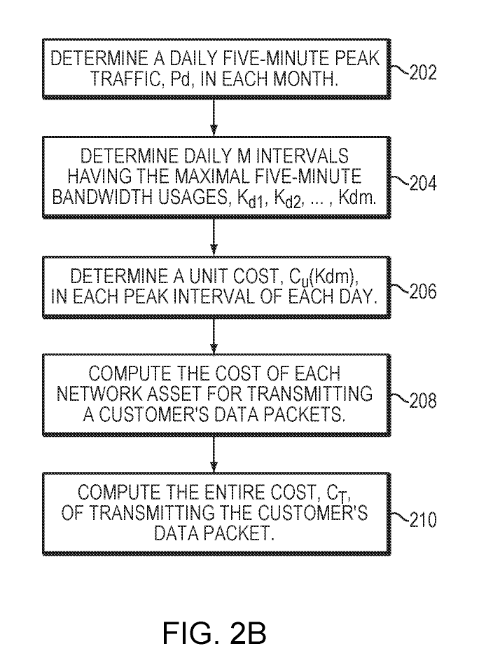

For each used network asset, a monthly depreciated cost, Cₘ, and maximum capacity of the allowed bandwidth usage, Bₘ, associated therewith are determined. In some embodiments, an M-peak approach, as further described below, determines a “unit cost” of the network asset; based on the determined unit cost and bandwidth usage of the customers, the network costs can be fairly allocated to the customers. Referring to FIGS. 2A and 2B, in a first step 202, a network operator's daily five-minute peak traffic of each network asset, P_{d} (where d denotes each date in the month), is determined using data collected from NetFlow and/or BGP/IGP. A daily cost of each asset, C_{d}, is then determined based on the ratio of the daily five-minute peak traffic, P_{d}, to the aggregated daily peaks throughout the month. For example, the daily costs of day 1 and day 2 on each asset may be computed as follows:

$${C}_{1} = \frac{{P}_{1}}{{P}_{1} + {P}_{2} + {P}_{3} + … + {P}_{N}} {C}_{m} ;$$

$${C}_{2} = \frac{{P}_{2}}{{P}_{1} + {P}_{2} + {P}_{3} + … + {P}_{N}} \times {C}_{m} ,$$

where N denotes the total number of days in each month.

In a second step 204, M intervals having the maximal five-minute bandwidth usages, K_{d1}, K_{d2}, K_{dM} on each day are determined by, again, analyzing the NetFlow data and/or BGP/IGP data. It is now assumed that the asset cost may be allocated only to those entities that are using this asset during these M peaks of each day. The asset is considered to be used free of charge for the rest of the time. In addition, each of these M peaks may have a different unit cost and that unit cost is determined based on the daily cost and usage in that peak interval.

In a third step 206, a unit cost in each peak interval, Cᵤ (K_{dM}), is determined using the following method:

$${C}_{u} ( {K}_{11} ) = {C}_{1} \times {K}_{11} / ( \frac{{K}_{11} \times {K}_{11}}{{K}_{11}} + \frac{{K}_{12} \times {K}_{12}}{{K}_{11}} + \frac{{K}_{13} \times {K}_{13}}{{K}_{11}} + … + \frac{{K}_{1 M} \times {K}_{1 M}}{{K}_{11}} )$$

$${C}_{u} ( {K}_{dM} ) = {C}_{d} \times {K}_{dM} / ( \frac{{K}_{d 1} \times {K}_{d 1}}{{K}_{dM}} + \frac{{K}_{d 2} \times {K}_{d 2}}{{K}_{dM}} + \frac{{K}_{d 3} \times {K}_{d 3}}{{K}_{dM}} + … + \frac{{K}_{dM} \times {K}_{dM}}{{K}_{dM}} )$$

In a fourth step 208, the cost of each asset for transmitting a customer's traffic, C (K_{dM}), is computed by multiplying the determined unit cost of each asset, Cᵤ (K_{dM}), with the usage,—i.e., C (K_{dM})=Cᵤ(K_{dM})×bit rate in the time interval K_{dM}.

Steps 1-4 are performed on each asset along the routing path from the source to the destination of the transmitted data packets. Finally, in a fifth step 210, the entire cost, C_{T}, of transmitting the customer's data packet is computed by aggregating the costs incurred from all assets along the routing path:

C_{T}=C(K_{dM})ₐₛₛₑₜ₁+C(K_{dM})ₐₛₛₑₜ₂+ . . . =Cᵤ(K_{dM})ₐₛₛₑₜ₁×bit rate+Cᵤ(K_{dM})ₐₛₛₑₜ₂×bit rate+ . . .

Accordingly, the M-peak approach allocates network costs based on various daily usages and the usage during the M allowed five-minute peaks (as opposed to a single peak level in the entire month). This approach ensures that the costs are fairly allocated to “consistent” users (since capacity planning and upgrades to the network infrastructure are typically triggered by consistent peak usage, rather than a single peak), while still accounting for the fact that most cost is allocated to the peak usage (which typically determines the capacity design and likelihood of future upgrades). In addition, because the costs are computed based on aggregation of all asset costs along the data routing path, the routing distance of the data and “expensiveness” of assets used are effectively taken into account in the pricing mechanism of the current invention. This approach also allows the network operator to fairly distribute costs associated with an asset upgrade to the relevant entities—i.e., entities that utilize the upgraded asset for transmitting data packets.

In various embodiments, a network cost policy having a set of cost attribution rules determines how the cost is allocated among customers. Certain types of rules may take precedence over others types. For example, rules involving the entity type (i.e., customers or settlement-free peers) may take precedence over rules involving classification of the entities (i.e., net senders or net receivers). As used herein, the term “customer” denotes a revenue-generating peer—i.e., a network operator or enterprise that pays another network operator for Internet access; the term “settlement-free peers” denotes two network operators exchanging traffic between theirs users freely and for mutual benefit; the term “entities” includes both customers and peers; the term “net senders” denotes entities that transmit more traffic than they receive and are typically billed for their sent traffic; and the term “net receivers” denotes entities that receive more traffic than they transmit and are typically billed for their received traffic.

In some embodiments, a cost attribution rule of the cost policy restricts the costs to be attributed to customers only and not to the settlement-free peers. For example, when a customer sends data to a settlement-free peer, the customer is attributed the entire cost of transmitting the data. Another cost attribution rule may regulate the costs to be attributed to the customers based on their classifications—i.e., whether they are net senders or net receivers. For example, when a net sender customer S₁ sends data to a net sender customer S₂, the net sender S₁ is attributed 100% of the transmission cost and net sender S₂ is billed for 0% (because S₂ is only billed for his sent traffic, which is zero in this case). Similarly, when a net receiver customer R₁ sends data to a net receiver customer R₂, the net receiver R₂ is attributed 100% of the transmission cost and net receiver R₁ is billed for 0% (because R₁ is only billed for his received traffic, which is zero in this case). If, however, data is transmitted from a net sender customer S₁ to a net receiver customer R₁, S₁ and R₁ are each attributed 50% of the transmission cost. Likewise, when the data is transmitted from a net receiver customer R1 to a net sender customer S₁, each of S₁ and R₁ is attributed 50% of the transmission cost even though R1 has zero received traffic and S₁ has zero sent traffic.

The cost attribution rules of the cost policy described herein represent exemplary embodiments only, and the present invention is not limited to such rules. One of ordinary skill in the art will understand that any variations that can fairly allocate network costs to the net senders and net receivers are possible and are thus within the scope of the present invention.

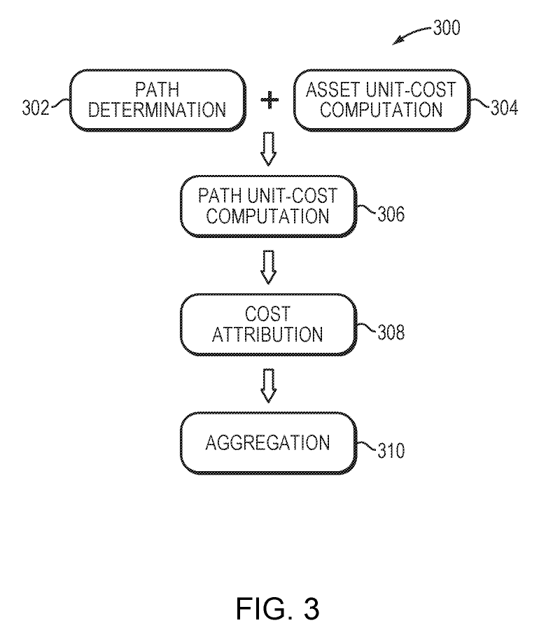

FIG. 3 is a flow chart illustrating an approach 300 for fairly allocating network costs to customers in accordance with various embodiments of the present invention. In a first step 302, upon receiving a request for transmitting a data set, the network operator determines traffic characteristics and a routing path using a network protocol (e.g., NetFlow) and an exterior/interior gateway protocol (e.g., IS-IS/BGP). In a second step 304, a unit cost of each asset on the determined routing path is computed using an interior gateway protocol (IGP) and the M-peak approach as described above. In a third step 306, a total cost of transmitting the data set is computed by aggregating the costs incurred from all relevant assets on the routing path. In a fourth step 308, the total cost is attributed to the customer(s) based on a network cost policy. In a fifth step 310, each customer's monthly cost is computed by aggregating his daily costs. Because this approach involves neither complex computation nor excessive setup, it can be easily and inexpensively implemented in conventional network systems as described in greater detail below.

The current invention advantageously allows the bandwidth usage and routing path of any flow on the network to be accurately determined by analyzing traffic data collected from, for example, NetFlow, BGP and/or IGP; and leverages that to enable the network operator to fairly determine the cost to the customer for the “real” bandwidth and network assets actually used. In addition, the network operator may simultaneously obtain real-time information about the network's traffic matrix and about data flows traversing each network device; based on this information together with the required bandwidth usage of the customer's traffic, the operator may adjust the routing path along which the data packets are forwarded. In some embodiments, adjustment of the routing paths is incorporated in the cost policy as a pricing rule, which then affects computation of the network cost allocations. For example, the network operator may offer his customers various types of services, each type having a different pricing rule for computing the network costs allocated to the customers. One representative pricing rule may define that the costs attributed to the customers depend on the degree of data queuing during data transmission—for example, a discount is applied to a computed network cost when the data packets are transmitted with more queuing (i.e., more delay) in the network. Thus, the operator may offer the customers a service that includes more aggressive queuing in a network at a much lower price than other networks that include less delay. This approach allows the customers to select network services based on their needs and allows the network operators to direct the traffic with flexibility.

Generally, a shortest routing path is selected to forward the traffic flow in routed networks. In some situations, however, a longer routing path (i.e., having more hops than the shortest path has) may be preferable as dictated by traffic flow and path information revealed using the cost analysis described herein. For example, the unit price of each network asset on a longer routing path may be much cheaper than that of the assets on the shortest path, and therefore, although more network assets may be involved on the longer routing path, the overall network cost is lower on the longer routing path than the cost on the shortest path. With this in mind, the network operator or a computational entity may adjust the routing or destination tables in various network forwarding entities (e.g., routers and switches) to achieve cost-optimal network utilization rather than, for example, the fastest possible transit or the shortest routing path.

In addition, when large flow values traverse network devices located on the shortest routing path and the addition of a new flow value to the currently traversed flow may exceed the devices' capacities, the network operator or a computational entity may route the requested traffic via a longer path. Accordingly, in some embodiments, a pricing rule applies a discount to the computed network cost when a shorter routing path is available, but the data packets are routed via a longer path either manually by the operator's adjustment and/or automatically by the network setting. When a request for transmitting a data set is from a customer who subscribes to a cheaper network service, the network operator may choose a routing path that is longer and has a lower overall network cost to deliver the data. This approach again allows the network operator to provide customers various levels of service with different prices. In addition, it advantageously provides the network operator flexibility in directing the traffic flow based on the real-time flow values and/or the overall network costs and fairly allocates the network costs to the customers reflecting such routing adjustments.

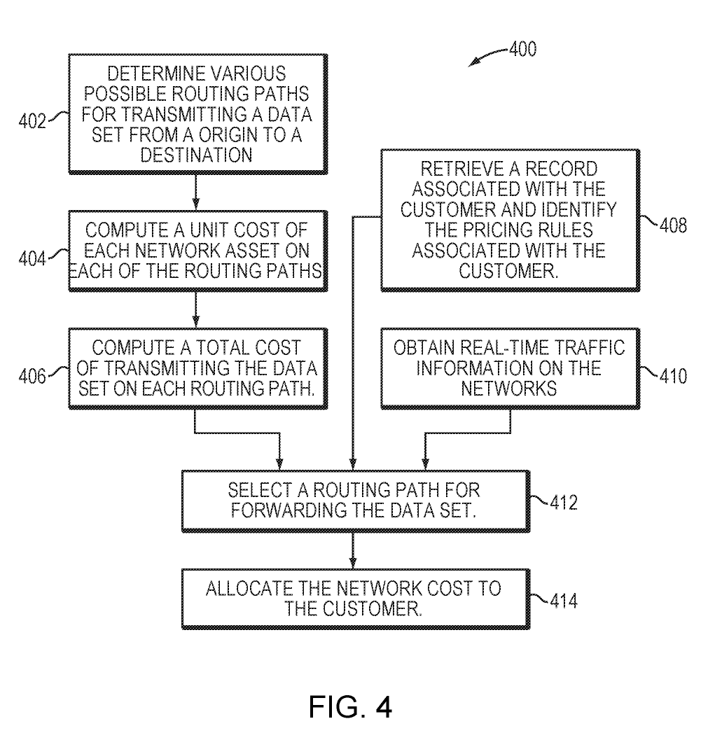

FIG. 4 is a flow chart illustrating an approach 400 for a network operator or computational entity to direct a traffic flow based on real-time traffic information and/or network costs along the routing paths between the data source and the data destination in accordance with various embodiments of the present invention. In a first step 402, upon receiving a request from a customer for a data set, the network operator determines various possible routing paths using a network protocol, such as intermediate system to intermediate system (IS-IS) and/or an exterior gateway protocol (e.g., BGP). In a second step 404, a unit cost of each network asset on each of the routing paths is computed using an interior gateway protocol (IGP) and the M-peak approach as described above. In a third step 406, a total cost of transmitting the data set on each routing path is computed by aggregating the costs incurred from all relevant assets thereon. In a fourth step 408, a record associated with the customer is accessed and the service plan subscribed by the customer is identified. In a fifth step 410, real-time traffic information on the networks is acquired using NetFlow, BGP, and/or other protocols. In a sixth step 412, a routing path for forwarding the data set is determined based on the network costs, the customer's service plan, and the real-time traffic information obtained in steps 406, 408, and 410, respectively. In a seventh step 412, the network cost is attributed to the customer based on the asset costs along the determined routing path and a network cost policy associated with the customer's subscribing plan.

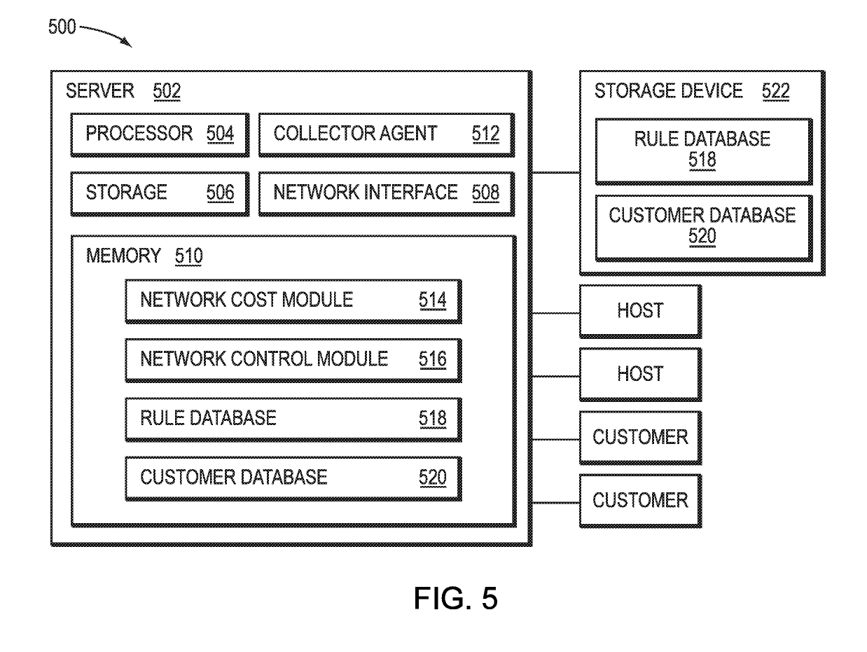

FIG. 5 is a schematic illustration of a system 500 for a network operator to allocate network costs to his customers and manipulate traffic flow in the networks in accordance with various embodiments. The system 500 has at least one server 502 that includes a computer processor 504, such as an INTEL XEON, non-volatile storage 506, such as a magnetic, solid-state, or flash disk, a network interface 508, such as ETHERNET or WI-FI, and a volatile memory 510, such as SDRAM. The storage 506 may store computer instructions which may be read into memory 510 and executed by the processor 504. The network interface 508 may be used to communicate with hosts and/or customers in a cluster. The present invention is not, however, limited to only the architecture of the server, and one of skill in the art will understand that embodiments of the present invention may be used with other configurations of servers or other computing devices.

The memory 510 may include instructions for low-level operation of the server 502, such as operating-system instructions, device-driver-interface instructions, or any other type of such instructions. The operating system may include one or more network protocols, such as NetFlow, exterior gateway protocols, and/or interior gateway protocol. Any operating system (such as WINDOWS, LINUX, or OSX) and/or other instructions are within the scope of the present invention, which is not limited to any particular type of operating system. In some embodiments, the server 502 further includes a collector agent 512 for collecting data from the network protocol(s), exterior gateway protocol(s), and/or interior gateway protocol(s). The memory 510 further includes instructions, such as a network cost module 514 for computing a network cost and a network control module 516 for determining a routing path for data packets.

A rule database 518 storing a cost policy having multiple pricing rules and/or a customer database 520 storing records associated with the customers (such as the customers' subscribing services) may reside in the server 502, such as in the memory 510 or the storage 506, and/or in a remote storage device 522, from which the server 502 can access and retrieve data. When the server 502 receives a request from a customer to forward data, the server 502 retrieves the customer's record and pricing rules applicable to the customer from the customer database 520 and the rule database 518, respectively. Based on this information, the processor 504 may compute a network cost attributed to the customers by executing the network cost module 514 and/or determine a routing path of the data set by executing the network control module 516. The latter module may alter packets constituting the data flow to specify the determined routing path (so that entries in the routing tables of forwarding tables are overridden), or, depending on the level of similar traffic, the network control module 516 may transmit messages to forwarding entities to modify their routing tables for certain types of data traffic in order to conform to the cost policy (rather than to a default routing algorithm such as shortest path) or to change the routing protocol applicable to such traffic.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method of allocating a network cost for delivering traffic from a source to a destination on a network, the method comprising:
collecting traffic information on the network;
determining a routing path from the source to the destination based on the traffic information using at least one routing protocol;
computing a unit cost of each network asset located along the determined routing path;
computing the network cost based on the unit cost of each network asset and a flow value associated with the traffic; and
allocating the network cost to network users in accordance with a cost policy.

2. The method of claim 1, wherein the traffic information is collected using at least one of a network protocol or an exterior gateway protocol.

3. The method of claim 1, wherein the flow value is a bit rate.

4. The method of claim 1, wherein the network assets are identified using an interior gateway protocol.

5. The method of claim 1, wherein the unit cost of each network asset is determined based on at least one of a monthly depreciated cost, an operating cost, a utilized bandwidth or a capacity of the asset.

6. The method of claim 5, further comprising computing a daily cost of each network asset based on a ratio of a daily five-minute peak traffic flow to an aggregation of the daily five-minute peak traffic flow in a month.

7. The method of claim 6, further comprising determining daily M intervals having maximal five-minute bandwidth usages.

8. The method of claim 7, wherein the unit cost is computed by dividing the daily cost by a proportion of bandwidth usage within the M intervals.

9. The method of claim 1, wherein the cost policy classifies the network users into net senders and net receivers, the net senders sending more traffic than they receive and net receivers receiving more traffic than they send.

10. The method of claim 1, wherein the network comprises a plurality of forwarding devices, and further comprising the step of altering routing protocols of the forwarding devices based on the traffic information and the network cost.

11. A system for allocating a network cost for delivering traffic from a source to a destination on a network, the system comprising:
a memory comprising a database for storing a cost policy;
a collector agent for collecting traffic information on the network; and
a processor configured to:
determine a routing path from the source to the destination based on the collected traffic information using at least one routing protocol;
compute a unit cost of each network asset located on the determined routing path;
compute the network cost based on the unit cost of each network asset and a flow value associated with the traffic; and
allocate the network cost to network users in accordance with the cost policy.

12. The system of claim 11, wherein the collector agent is configured to collect the traffic information from at least one of a network protocol or an exterior gateway protocol.

13. The system of claim 11, wherein the flow value is a bit rate.

14. The system of claim 11, wherein the assets are identified using an interior gateway protocol.

15. The system of claim 11, wherein the processor is further configured to determine the unit cost of each network asset based on at least one of a monthly depreciated cost, an operating cost, a utilized bandwidth, or a capacity of the asset.

16. The system of claim 15, wherein the processor is further configured to compute a daily cost of each network asset based on a ratio of a daily five-minute peak traffic flow to an aggregation of the daily five-minute peak traffic flows in a month.

17. The system of claim 16, wherein the processor is further configured to determine daily M intervals having maximal five-minute bandwidth usages.

18. The system of claim 17, wherein the processor is further configured to compute the unit cost by dividing the daily cost by a proportion of bandwidth usage within the M intervals.

19. The system of claim 11, wherein the cost policy classifies the network users into net senders and net receivers, the net senders sending more traffic than they receive and net receivers receiving more traffic than they send.

20. The method of claim 11, wherein the network comprises a plurality of forwarding devices, and the processor is further configured to alter routing protocols of the forwarding devices based on the traffic information and the computed network cost.

21. A method of routing a data set from a source to a destination, the method comprising:
collecting traffic information on the network;
determining a plurality of routing paths from the source to the destination;
computing a network cost associated with each one of the routing paths;
selecting one of the plurality of routing paths based on the associated network costs, a flow value associated with the data set, and the collected traffic information.

22. The method of claim 21, further comprising:
retrieving a customer's record, the customer being associated with at least one of the source or the destination,
retrieving a cost policy associated with the customer's record, and
selecting one of the plurality of routing paths based at least in part on the cost policy.

23. The method of claim 21, wherein the traffic information is collected using at least one of a network protocol or an exterior gateway protocol.

24. The method of claim 21, wherein the flow value is a bandwidth.

25. The method of claim 21, wherein the network cost associated with each one of the routing paths is determined based on a unit cost of each network asset located on the routing paths and a bit rate of the data set.

26. The method of claim 25, wherein the network assets are identified using an interior gateway protocol.

27. The method of claim 25, wherein the unit cost of each network asset is determined based on at least one of a monthly depreciated cost, an operating cost, a utilized bandwidth or a capacity of the asset.

28. The method of claim 27, further comprising computing a daily cost of each network asset based on a ratio of a daily five-minute peak traffic flow to an aggregation of the daily five-minute peak traffic flow in a month.

29. The method of claim 28, further comprising determining daily M intervals having maximal five-minute bandwidth usages.

30. The method of claim 29, wherein the unit cost on is computed by dividing the daily cost by a proportion of bandwidth usage within the M intervals.

31. A system for routing a data set from a source to a destination on a network, the system comprising:
a collector agent for collecting traffic information on the network; and
a processor configured to:
determine a plurality of routing paths from the source to the destination;
compute a network cost associated with each one of the routing paths; and
select one of the plurality of routing paths based on the associated network costs, a flow value associated with the data set, and the collected traffic information.

32. The system of claim 31, further comprising:
a first database for storing customer records; and
a second database for storing a plurality of cost policy rules;
wherein the processor is further configured to:
retrieve, from the first database, a customer's record, the customer being associated with at least one of the source or the destination,
retrieve, from the second database, a cost policy rule associated with the customer's record, and
select one of the plurality of routing paths based at least in part on the retrieved cost policy rule.

33. The system of claim 31, wherein the collector agent is configured to collect the traffic information from at least one of a network protocol or an exterior gateway protocol.

34. The system of claim 31, wherein the flow value is a bandwidth.

35. The system of claim 31, wherein the processor is further configured to determine the network cost associated with each one of the routing paths based on a unit cost of each network asset located on the routing paths and a bit rate of the data set.

36. The system of claim 35, wherein the network assets are identified using an interior gateway protocol.

37. The system of claim 35, wherein the processor is further configured to determine the unit cost of each network asset based on at least one of a monthly depreciated cost, an operating cost, a utilized bandwidth, or a capacity of the asset.

38. The system of claim 37, wherein the processor is further configured to compute a daily cost of each network asset based on a ratio of a daily five-minute peak traffic flow to an aggregation of the daily five-minute peak traffic flow in a month.

39. The system of claim 38, wherein the processor is further configured to determine daily M intervals having maximal five-minute bandwidth usages.

40. The system of claim 39, wherein the processor is further configured to compute the unit cost by dividing the daily cost by a proportion of bandwidth usage within the M intervals.
